(19) United States
(12) Patent Application Publication
(10) Pub. No.: US 2026/0363490 A1
(43) Pub. Date: Nov. 19, 2026

(54) MULTI-FUNCTIONAL FOOD PREPARATION AND COOKING APPLIANCE

(71) Applicant: Imam Abdulrahman Bin Faisal University, Dammam (SA)

(72) Inventors: Salihah Abdulrahman HUMAID, Dammam (SA); Noran QATTAN, Dammam (SA); Khadijah AL KHUWAITEM, Dammam (SA); Amal ALKHAYYAL, Dammam (SA); Hala EL-WAKEEL, Dammam (SA)

(73) Assignee: Imam Abdulrahman Bin Faisal University, Dammam (SA)

(21) Appl. No.: 19/208,132

(22) Filed: May 14, 2025

(51) Int. Cl. A47J 44/02; A47J 36/02; A47J 36/06; A47J 43/044; A47J 43/046; A47J 43/07; A47J 43/08; A47J 45/06

(52) U.S. Cl. CPC A47J 44/02; A47J 36/025; A47J 36/064; A47J 43/046; A47J 43/0727; A47J 43/087; A47J 45/061; A47J 2043/0449

(57) ABSTRACT

An integrated cooking appliance and method of use comprising an appliance base, a central support structure located on the appliance base, a blender unit located on the appliance base and connected to a first side of the central support structure, and a platform hingeably connected to the first side of the central support structure. The platform is located above the blender unit. The integrated cooking appliance further comprises a food processor unit located on the platform above the blender unit, and a cooking unit located on the appliance base and connected to a second side of the central support structure. The cooking unit comprises a heating element located within the appliance base on the second side. The integrated design conserves counter space and streamlines the preparation of complete meals, particularly breakfast, by enabling multiple food preparation techniques to occur within a unified, ergonomically designed appliance.

### BACKGROUND

### Technical Field

The present disclosure is directed to kitchen appliances, and more particularly to integrated, multi-functional food preparation and cooking appliances that combine food processing, blending, and heating capabilities in a single unit.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In modern households, kitchen counter space is often limited, yet the number of specialized appliances continues to grow. Conventional kitchens typically require separate appliances for different food preparation tasks, such as dedicated blenders, food processors, and cooking pans with heating elements, each occupying valuable counter space and requiring separate storage when not in use. This large number of single-function appliances creates challenges for users with limited kitchen space and complicates meal preparation that requires multiple cooking techniques.

Traditional breakfast preparation often necessitates the simultaneous use of multiple appliances, creating a cumbersome workflow, especially during busy morning routines. Caregivers face particular challenges when preparing breakfast for children, as they must coordinate various cooking processes across different appliances while managing time constraints. Existing multi-function appliances often compromise in functionality, offering suboptimal performance in one or more of their integrated functions compared to dedicated single-function devices. Additionally, current kitchen appliances typically operate as standalone units without the ability to connect with smart devices for enhanced functionality, recipe management, or social sharing of cooking experiences.

CN105725828A describes a juicer having a heating and stirring cup, a display screen, and a heating element to heat the heating and stirring cup, wherein juice can be poured from the juicer into the heating and stirring cup. The said juicer provides basic heating functionality but lacks an integrated approach to meal preparation. This reference does not provide a unified cooking solution that integrates blending, food processing, and cooking capabilities arranged around a central structural element.

US20210235935A1 describes a foodstuffs preparation and/or cooking appliance having a cooking bowl, a base, a weighing device, a lid, a column including a heating member, and a tub. The system includes a controller, a drive motor connected by a transmission and a drive shaft to a cutting and/or blending member disposed in the bowl. The device offers some integration of functions but remains limited in simultaneous food preparation capabilities. This reference does not provide a unified cooking solution that integrates blending, food processing, and cooking capabilities arranged around a central structural element.

US20220257057A1 describes a food preparation appliance, a food preparation accessory, a remote communication device, a network, and a data store. The food preparation appliance is capable of assisting a user in preparing food, with embodiments including capabilities for chopping, dicing, cutting, weighing, storing, heating, cooling, and/or maintaining temperature of food items. This reference does not provide a unified cooking solution that integrates blending, food processing, and cooking capabilities arranged around a central structural element.

Each of the aforementioned references suffers from one or more drawbacks hindering their adoption, such as limited functional integration, inefficient use of counter space, inability to perform multiple food preparation tasks simultaneously, and lack of connectivity with digital platforms for recipe management and sharing. These limitations often result in users purchasing multiple single-function appliances, leading to cluttered kitchens, increased expenses, and complicated meal preparation workflows.

Accordingly, it is an object of the present disclosure to provide an integrated multi-functional food preparation and cooking appliance that combines multiple food preparation functions in a space-efficient design while maintaining performance comparable to dedicated appliances and incorporating digital connectivity features that enhance the user experience.

### SUMMARY

In an exemplary embodiment, an integrated cooking appliance is described, comprising: an appliance base; a central support structure located on the appliance base; a blender unit located on the appliance base and connected to a first side of the central support structure; a platform hingeably connected to the first side of the central support structure, wherein the platform is located above the blender unit; a food processor unit located on the platform above the blender unit; and a cooking unit located on the appliance base and connected to a second side of the central support structure, wherein the cooking unit comprises a heating element located within the appliance base on the second side.

In another exemplary embodiment, a method of using an integrated cooking appliance system, comprising: selecting, by a user of the integrated cooking appliance system, including a set of instructions for preparing a recipe from a group of food ingredients by one or more of slicing, cutting and dicing a first portion of the group of food ingredients, blending a second portion of the group of food ingredients and cooking a third portion of the group of food ingredients; placing the first portion of the group of the food ingredients into a food processor carafe; placing the second portion of the group of the food ingredients into a blender carafe; placing the third portion of the group of the food ingredients into a cooking pan; placing a lid selected from a plurality of cooking pan lids over the cooking pan; rotating upward, by a hinge connected to a first side of a central support structure, a platform connected to the hinge, wherein the platform is located at a height halfway between an appliance base and an upper compartment of an integrated cooking appliance of the integrated cooking appliance system; inserting, by the user, the blender carafe onto an appliance base located on the first side of a central support structure of the integrated cooking appliance and beneath the platform; inserting a first end of a blender shaft into a blender lid, a blender bushing and a blender motor located within the platform; inserting, by the user, a second end of the blender shaft into the blender carafe, wherein the second end is configured with a whisk blade; covering, by the user, the blender carafe and blender lid by rotating the platform downward; inserting, by the user, the food processor carafe into a food processor receiving region located on an upper surface of the platform; inserting, by the user, a first end of a food processor shaft to a first food processor bushing located within the platform directly above a food processor motor, wherein the first food processor bushing is configured to connect the first end of the food processor shaft through an opening in a base of the food processor carafe to the food processor motor located within the platform; inserting, by the user, a food processor blade consisting of one of a slicing, cutting and dicing blade as required by the instructions into a blade drawer located in an upper compartment of a central support structure integrated cooking appliance; inserting, by the user, a second end of the food processor shaft into a second food processor bushing located within the upper compartment beneath the food processor blade and into a central hub of the food processor blade; placing, by the user, the cooking pan over a heating element located on the base on a second side of the central support structure; and preparing the recipe by actuating one or more of the blender motor, the food processor motor and the heating element, as required by the set of instructions.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary perspective view of an integrated cooking appliance, according to certain embodiments.

FIG. 1B is an exemplary wireframe perspective view of the integrated cooking appliance, according to certain embodiments.

FIG. 1C is an exemplary side view with dimensions of the integrated cooking appliance, according to certain embodiments.

FIG. 1D is an exemplary front view with dimensions of the integrated cooking appliance, according to certain embodiments.

FIG. 1E is an exemplary top view with dimensions of the integrated cooking appliance, according to certain embodiments.

FIG. 1F is an exemplary exploded view of the integrated cooking appliance showing component parts and their spatial relationships, according to certain embodiments.

FIG. 2 is an exemplary diagram illustrating a wiring harness of the integrated cooking appliance, according to certain embodiments.

FIG. 3 is an exemplary schematic diagram depicting implementation of a savor moment computing application registered to a user of the integrated cooking appliance, according to certain embodiments.

FIG. 4A is an exemplary first display interface of the savor moment computing application showing selectable function options for the integrated cooking appliance, according to certain embodiments.

FIG. 4B is an exemplary second display interface of the savor moment computing application showing functional icons for food preparation operations, according to certain embodiments.

FIG. 4C is an exemplary third display interface of the savor moment computing application showing recipe information including ingredients and preparation steps, according to certain embodiments.

FIG. 4D is an exemplary fourth display interface of the savor moment computing application showing recipe thumbnail images, according to certain embodiments.

FIG. 4E is an exemplary fifth display interface of the savor moment computing application showing user account information and registered appliance data, according to certain embodiments.

FIG. 4F is an exemplary sixth display interface of the savor moment computing application showing a community blog section, according to certain embodiments.

FIG. 5 is an exemplary flowchart listing steps involved in a method of using the integrated cooking appliance system, according to certain embodiments.

FIG. 6 is an illustration of a non-limiting example of details of computing hardware used in the computing system, according to certain embodiments.

FIG. 7 is an exemplary schematic diagram of a data processing system used within the computing system, according to certain embodiments.

FIG. 8 is an exemplary schematic diagram of a processor used with the computing system, according to certain embodiments.

FIG. 9 is an illustration of a non-limiting example of distributed components which may share processing with the controller, according to certain embodiments.

### DETAILED DESCRIPTION

In the drawings like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to an integrated cooking appliance and a method of using an integrated cooking appliance that addresses the limitations of existing kitchen appliances by combining multiple food preparation functions in a unified, space-efficient design. The integrated cooking appliance enables users to perform various food preparation tasks including blending, food processing, and cooking within a single appliance, eliminating the need for multiple separate devices. In the integrated cooking appliance, the arrangement of components optimizes counter space usage while maintaining full functionality for each component, and the integrated digital connectivity features expand its capabilities beyond physical functions. The method of using the integrated cooking appliance provides a workflow for preparing complete meals, particularly breakfast items, by enabling simultaneous preparation of different meal components using the various integrated functions.

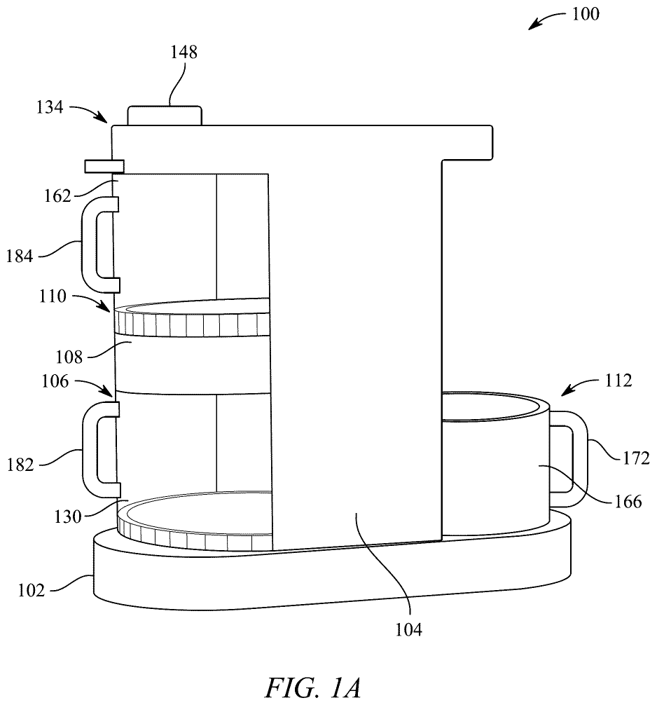

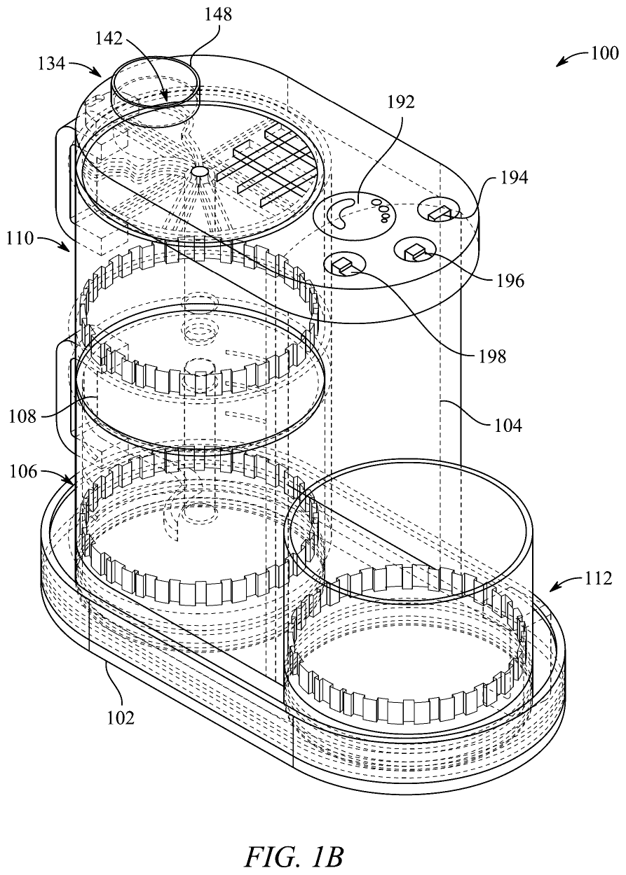

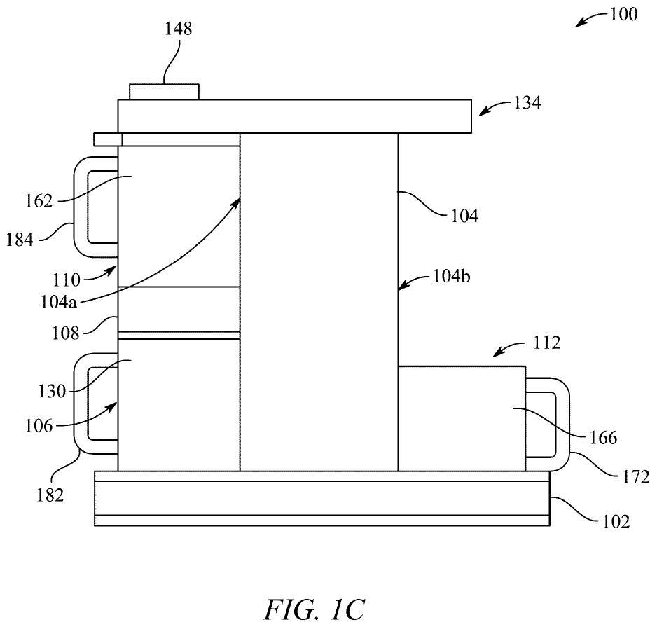

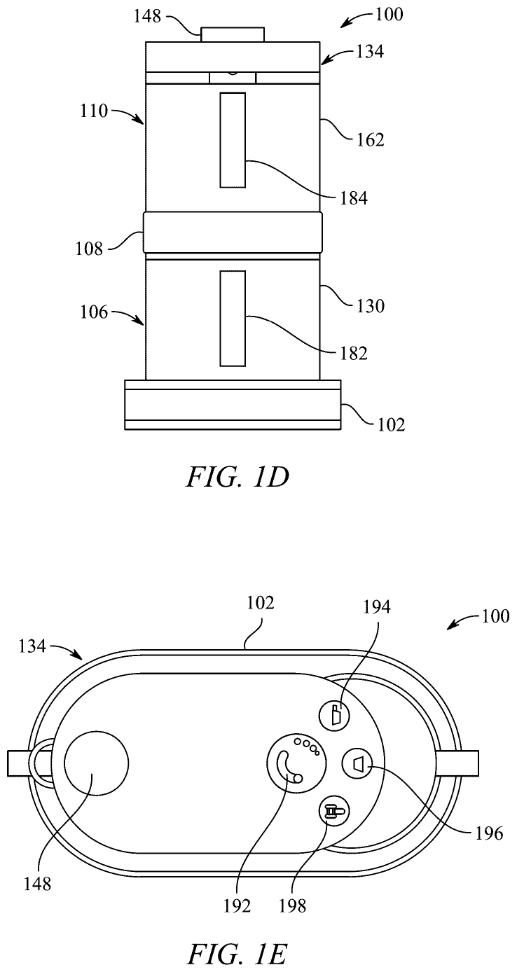

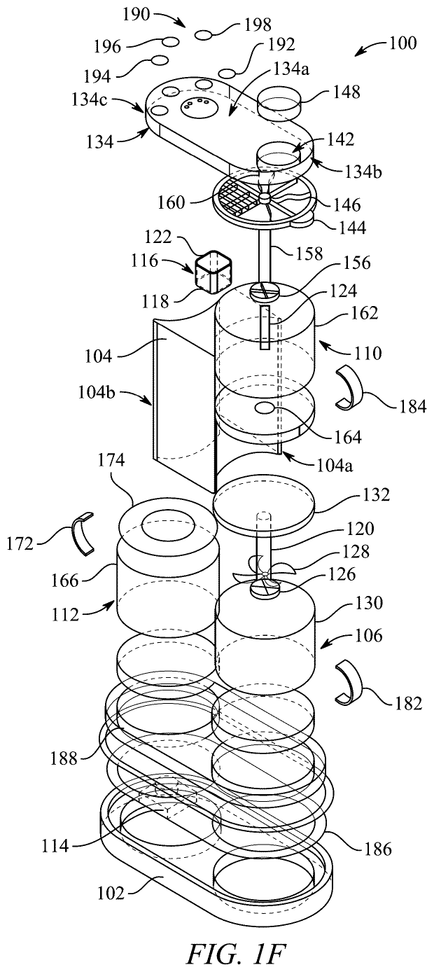

Referring now to the drawings, FIG. 1A-1E illustrate various views of an integrated cooking appliance (as represented by reference numeral 100) according to an embodiment of the present disclosure. Further, FIG. 1F illustrates an exploded view of the integrated cooking appliance 100, showing its different component and their spatial relationships. The integrated cooking appliance 100 of the present disclosure is configured to provide multiple cooking and food preparation functionalities in a single, space-efficient unit, particularly suited for preparing breakfast items. The integrated cooking appliance 100 addresses the needs of modern kitchens where space and efficiency are some concerns of busy individuals or caregivers preparing meals under time constraints. By integrating technologies typically found in separate appliances, the integrated cooking appliance 100 enables users to prepare multiple components of a meal simultaneously without cluttering counter space with numerous devices.

As illustrated, the integrated cooking appliance 100 includes an appliance base 102, a central support structure 104 located on the appliance base 102, a blender unit 106 located on the appliance base 102 and connected to a first side 104a of the central support structure 104, a platform 108 hingeably connected to the first side 104a of the central support structure 104. Herein, the platform 108 is located above the blender unit 106. The integrated cooking appliance 100 further includes a food processor unit 110 located on the platform 108 above the blender unit 106, and a cooking unit 112 located on the appliance base 102 and connected to a second side 104b of the central support structure 104. The cooking unit 112 includes a heating element 114 located within the appliance base 102 on the second side 104b.

The appliance base 102 forms the foundation of the integrated cooking appliance 100 and provides a stable support for all the functional components. The appliance base 102 is constructed from durable materials capable of supporting the weight of the appliance and withstanding operational stresses. The appliance base 102 has an elongated oval shape, as better shown in the top view of FIG. 1D, with sufficient size to accommodate all functional components. The appliance base 102 provides a non-slip surface for the integrated cooking appliance 100 to prevent movement during operation. The appliance base 102 also houses internal electrical components, including the heating element 114 of the integrated cooking appliance 100.

The central support structure 104 extends vertically from the appliance base 102 and serves as the primary structural element connecting all major components of the integrated cooking appliance 100. The central support structure 104 is positioned centrally on the appliance base 102, and is designed to support the platform 108 as well as an upper compartment (described later) in the integrated cooking appliance 100. In some examples, the central support structure 104 may include internal channels for electrical wiring to connect different functional units of the integrated cooking appliance 100. The central support structure 104 may be constructed from heat-resistant materials for safe operation. The central support structure 104 also functions as a visual divider between the blending/food processing side and the cooking side of the integrated cooking appliance 100.

The blender unit 106 is positioned on the appliance base 102 on the first side 104a of the central support structure 104. The blender unit 106 is configured to process liquids and soft foods into smooth mixtures, purees, or drinks. The blender unit 106 includes a connection point for receiving rotational force from a blender motor (described later) located within the platform 108, and structural elements to securely hold a blender carafe in position during operation. The blender unit 106 may incorporate safety features that prevent operation unless it is properly seated and the platform 108 is in a lowered position, thereby enhancing user safety during operation of the integrated cooking appliance 100.

The platform 108 is hingeably connected to the first side 104a of the central support structure 104 and positioned above the blender unit 106. The platform 108 is designed to rotate upward to allow access to the blender unit 106 and to rotate downward to provide a stable base for the food processor unit 110. The hinge mechanism connecting the platform 108 to the central support structure 104 is designed to withstand frequent rotation while maintaining alignment and stability in both the raised and lowered positions. The platform 108 houses internal components including motors, bushings, and electrical connections that drive both the blender unit 106 below and the food processor unit 110 above, optimizing space utilization through this dual-purpose design. The platform 108 may also include locking mechanisms to secure it in the lowered position during operation, ensuring safety and stability during high-speed operation of the food processor unit 110 or the blender unit 106.

The food processor unit 110 is located on the platform 108, positioned above the blender unit 106 when the platform 108 is in the lowered position. The food processor unit 110 is designed to process solid foods through slicing, dicing, or chopping actions. The food processor unit 110 includes a connection point for receiving rotational force from a food processor motor (described later) contained within the platform 108. The food processor unit 110 is designed to accommodate interchangeable blades for different food processing functions, providing versatility for various food preparation tasks. The food processor unit 110 may also incorporate safety features that prevent operation unless all components are properly assembled and secured, protecting users from accidental activation during blade changes or other food processing operations.

The cooking unit 112 is located on the appliance base 102 on the second side 104b of the central support structure 104, opposite to the blender unit 106. The cooking unit 112 provides a heated surface for cooking foods directly or heating cookware placed upon it. The cooking unit 112 includes the heating element 114 located within the appliance base 102 on the second side 104b. The cooking unit 112 may also include a surface area designed to accommodate a cooking pan, and thermal insulation to protect the appliance base 102 and surrounding areas from excessive heat transfer. The cooking unit 112 is configured with temperature control mechanisms to provide adjustable heating levels for different cooking requirements, from gentle warming to high-temperature cooking. The cooking unit 112 may also incorporate safety features, including overheat protection, automatic shut-off capabilities, and heat-resistant materials surrounding the heating area to prevent accidental burns during operation.

The heating element 114 is positioned within the appliance base 102 beneath the cooking unit 112 and generates the thermal energy required for cooking operations. The heating element 114 is electrically connected to a control system (as discussed later) of the integrated cooking appliance 100, allowing user control of temperature settings through the selectable switches. The heating element 114 is configured to provide even heat distribution across the cooking surface. The heating element 114 may incorporate thermal regulation components to maintain consistent temperatures according to user settings, for performing cooking tasks with the integrated cooking appliance 100.

The integrated cooking appliance 100 also includes a dual motor 116 located within the platform 108. Herein, the dual motor 116 includes a blender motor 118 having a blender shaft 120 and a food processor motor 122 having a food processor motor shaft 124. Further, the blender motor 118, the blender shaft 120, the food processor motor 122 and the food processor motor shaft 124 are coaxial. The integrated cooking appliance 100 further includes a blender bushing 126 located within the platform 108 directly beneath the blender motor 118. Herein, the blender bushing 126 is configured to connect a first end of the blender shaft 120 to the blender motor 118. The integrated cooking appliance 100 further includes a whisk blade 128 connected to a second end of the blender shaft 120. The integrated cooking appliance 100 further includes a blender carafe 130 and a blender carafe lid 132 having an opening configured to receive the blender shaft 120.

In the present configuration, the dual motor 116 is configured to provide power to both the blender unit 106 and the food processor unit 110 while being contained entirely within the platform 108. The dual motor 116 consists of two distinct motor components, i.e., the blender motor 118 and the food processor motor 122, arranged coaxially to minimize space requirements while maximizing functional efficiency. The blender motor 118 is positioned to direct force downward towards the blender unit 106, whereas the food processor motor 122 is positioned to direct force upward towards the food processor unit 110. The dual motor 116 is designed with independent control systems that allow each motor component to operate separately, enabling the user to utilize either the blender function or the food processor function without activating both simultaneously.

In the integrated cooking appliance 100, the blender motor 118 is configured to provide the high rotational speeds as required for effective blending operations. The blender motor 118 is positioned within the dual motor 116 assembly with its drive axis aligned vertically to transmit power to the blender shaft 120. The blender motor 118 may feature variable speed capabilities, allowing users to select appropriate rotational speeds for different blending tasks, from gentle mixing to high-speed puréeing. Herein, the blender shaft 120 is a rigid component that transmits rotational force from the blender motor 118 to the whisk blade 128. The blender shaft 120 extends vertically from the blender motor 118 through the blender bushing 126, through the opening in the blender carafe lid 132, and into the blender carafe 130 where it connects to the whisk blade 128. The blender shaft 120 includes connection points at both ends, such that its first end connects securely to the blender motor 118 via the blender bushing 126, while its second end provides a connection point for the whisk blade 128, ensuring efficient power transfer throughout blender unit 106 of the integrated cooking appliance 100.

Further, the food processor motor 122 is configured to provide the vibrational speeds required for effective food processing operations, including slicing, dicing, and chopping. The food processor motor 122 is positioned within the dual motor 116 with its drive axis aligned vertically to transmit power upward to the food processor motor shaft 124. The food processor motor 122 may also feature variable speed capabilities, allowing users to select appropriate vibrational speeds for processing different food types and achieving desired consistency results. The food processor motor shaft 124 is a rigid component that transmits vibrational force from the food processor motor 122 to a food processor blade (as discussed later). The food processor motor shaft 124 extends vertically from the food processor motor 122 through the platform 108 and into a food processor carafe (as discussed later), where it ultimately connects to the selected food processor blade. The food processor motor shaft 124 includes connection points at both ends, such that its one end connects securely to the food processor motor 122, while its other end provides a secure connection to the food processor bushing system that drives the selected food processor blade.

The motor is a single integrated unit capable of operating in two separate modes: vibration from the upper side and rotation from the lower side. The two modes operate independently and are not active simultaneously. The motor remains fixed in place during manufacturing and is not manually installed or removed by the user.

For the food processing function, the user assembles the shaft inside the food processing carafe, mounts the cutting blade on top, and rotates the blade to align the desired cutting section. When the carafe is properly installed, the shaft engages automatically with the motor from below. Upon pressing the corresponding button, the motor produces vibration motion from the upper side to assist in cutting vegetables or fruits.

This design ensures ease of use by enabling automatic shaft engagement with the motor without manual adjustment, enhancing operational efficiency and user convenience.

Similarly, the user inserts the blender shaft into the center of the blender carafe. When the carafe is correctly positioned in the device, the shaft automatically engages with the motor. Once properly seated, the user presses the designated button to activate blending, and the motor rotates the shaft to perform the blending function.

Furthermore, the blender bushing 126 is a connecting component located within the platform 108 directly beneath the blender motor 118, and functions as an interface between the blender motor 118 and the blender shaft 120, securing the first end of the blender shaft 120 to the drive output of the blender motor 118. The blender bushing 126 may incorporate bearing elements that support the blender shaft 120 during rotation, reducing friction and wear while maintaining precise positioning during operation. The whisk blade 128 is connected to the second end of the blender shaft 120 and performs the actual blending function within the blender carafe 130. The whisk blade 128 is designed with multiple angled surfaces that create both vertical and horizontal flow patterns within the blender carafe 130 during rotation, ensuring thorough mixing of ingredients. In an example, the whisk blade 128 is constructed from food-grade stainless steel. The connection between the whisk blade 128 and the blender shaft 120 is designed to be secure during operation while also allowing for removal for cleaning or replacement when necessary.

Moreover, the blender carafe 130 serves as the container for holding ingredients during blending operations. The blender carafe 130 is designed with a shape that promotes efficient circulation of ingredients during blending, with curved interior surfaces that direct ingredients toward the whisk blade 128. The blender carafe 130 may incorporate measurement markings on its exterior to assist users in adding desired quantities of ingredients. The blender carafe 130 may also include a pour spout to facilitate dispensing of blended contents and a handle for secure gripping during placement, removal, and pouring operations. Further, the blender carafe lid 132 is designed to securely cover the blender carafe 130 during operation, preventing contents from splashing or spilling during high-speed blending. The blender carafe lid 132 has the opening that is adapted to accommodate the blender shaft 120. The blender carafe lid 132 is designed to be easily removable for cleaning while providing secure coverage during operation of the blender unit 106, in the integrated cooking appliance 100.

The integrated cooking appliance 100 also includes an upper compartment 134 located on the central support structure 104. The upper compartment 134 includes a central portion 134a located directly over the central support structure 104, a first portion 134b configured to extend over the first side 104a and a second portion 134c configured to extend at least partially over the second side 104b. The integrated cooking appliance further includes a food chute 142 located within the first portion 134b of the upper compartment 134. The integrated cooking appliance further includes a blade drawer for receiving a food processor blade 146. Herein, the blade drawer is located within the first portion 134b below the food chute 142. Further, a removable cover 148 is located on a top surface of the integrated cooking appliance 100.

The upper compartment 134 forms the top section of the integrated cooking appliance 100 and is mounted on the central support structure 104. The upper compartment 134 provides housing for various functional components and is divided into three distinct regions: the central portion 134a positioned directly above the central support structure 104, the first portion 134b that extends over the first side 104a above the food processor unit 110, and the second portion 134c that extends at least partially over the second side 104b above the cooking unit 112. Herein, the central portion 134a of the upper compartment 134 is positioned directly above the central support structure 104 and serves as the main junction point connecting the first portion 134b and the second portion 134c. The central portion 134a houses electronic control systems of the integrated cooking appliance 100. The central portion 134a includes internal channels for routing electrical wiring to different functional areas of the appliance. The first portion 134b of the upper compartment 134 extends over the first side 104a of the central support structure 104, positioning it above the food processor unit 110. The first portion 134b houses the food chute 142 and the blade drawer, for food processing operations. The first portion 134b also incorporates user interface elements including portions of the removable cover 148 that provide access to the food processing functions. The second portion 134c of the upper compartment 134 extends at least partially over the second side 104b of the central support structure 104, positioning it above part of the cooking unit 112. The second portion 134c houses the plurality of selectable switches that control the various functions of the integrated cooking appliance 100.

The food chute 142 is located within the first portion 134b of the upper compartment 134 and serves as the entry point for food items being processed by the food processor unit 110. The food chute 142 is designed with appropriate dimensions to accommodate various food items while guiding them toward the food processor blade 146 for accurate cutting, slicing, or dicing. The food chute 142 is constructed from food-grade materials that are easy to clean and resistant to staining from food pigments. In some examples, the food chute 142 may also be provided with a food pusher accessory that allows users to safely guide food items toward the food processor blade 146 without placing hands near the cutting area.

The blade drawer is located within the first portion 134b of the upper compartment 134, positioned below the food chute 142. The blade drawer is designed to securely house the food processor blade 146, positioning it optimally to process food items inserted through the food chute 142. The food processor blade 146 is the active cutting component of the food processor unit 110, performing the actual food processing function. The blade drawer is adapted as a removable component that slides into position, allowing for easy installation and removal of different food processor blades.

In an aspect of the present disclosure, the food processor blade 146 is selected from a set of food processor blades, including: a cutting blade; a dicing blade; and a chopping blade, such that the food processor blade 146 is configured to one of dice, slice and chop food inserted into the food chute 142 located in the removable cover 148 of the food processor unit 110. Each blade type in the set of food processor blades is designed for a specific food processing task. For instance, the cutting blade may be selected to produce clean slices, the dicing blade may be selected to produce uniform cubes, and the chopping blade may be selected to produce coarser, irregular pieces.

The cutting blade is a single integrated blade divided into four sections, with each section configured to cut vegetables or fruits into a different specific shape. The user selects the desired cutting shape by manually rotating the blade assembly using a designated handle or gripping point attached to the blade. This allows the user to easily turn the blade right or left to align the desired section toward the fruit or vegetable.

Once the appropriate section is selected, the blade is securely fixed onto the shaft and remains stationary (does not rotate) during operation. The cutting process is facilitated by vibration motion, assisting in slicing the produce efficiently. The design eliminates the need for multiple interchangeable blades, providing four cutting options in a single blade unit, thus enhancing user convenience and reducing setup complexity.

The removable cover 148 is located on the top surface of the integrated cooking appliance 100 and provides access to internal components while protecting them during operation. The removable cover 148 is designed to be easily detached for cleaning or maintenance while forming a secure seal during operation to prevent food particles from entering the internal mechanisms.

The integrated cooking appliance 100 also includes a first food processor bushing 156 located within the platform 108 directly above the food processor motor 122. The first food processor bushing 156 is configured to connect a first end of a food processor shaft 158 to the food processor motor shaft 124. The integrated cooking appliance 100 further includes a second food processor bushing 160 located within the second portion 134c beneath the food processor blade 146. The second food processor bushing 160 is configured to rotatably attach a second end of the food processor shaft 158 to a central hub of a selected food processor blade 146.

The first food processor bushing 156 acts as a connecting component located within the platform 108 directly above the food processor motor 122. The first food processor bushing 156 functions as an interface between the food processor motor shaft 124 and the food processor shaft 158, securing the first end of the food processor shaft 158 to the drive output of the food processor motor 122. The second food processor bushing 160 is located within the second portion 134c of the upper compartment 134, positioned beneath the food processor blade 146. The second food processor bushing 160 acts as an upper support and connection point for the food processor shaft 158, rotatably attaching the second end of the shaft to the central hub of the selected food processor blade 146. The second food processor bushing 160 is designed to maintain alignment between the food processor shaft 158 and the food processor blade 146 while allowing smooth rotation during operation.

In the assembly of the food processing compartment, the shaft is inserted into the carafe, the cutting blade is mounted on top of the shaft, and the complete assembly is then smoothly inserted into its corresponding position in the device without requiring any additional mechanical adjustments or complex actions.

The upper compartment of the device is not removable. Both the blender carafe and the food processor carafe are assembled together with their respective shafts. The shaft is first inserted into the corresponding carafe (either for blending or food processing), and the complete assembly is then mounted into the device through a guided sliding motion.

The design dimensions of the carafes and shafts are specifically engineered to enable smooth insertion without obstruction or operational difficulties. Upon full insertion into the designated housing, an audible click from the safety lock mechanism confirms correct positioning.

Herein, the food processor shaft 158 is a rigid component that transmits rotational force from the food processor motor 122 to the food processor blade 146. The food processor shaft 158 extends vertically from the first food processor bushing 156 through the platform 108, through a food processor carafe (as discussed in proceeding paragraphs), and connects to the second food processor bushing 160 which attaches to the central hub of the selected food processor blade 146. The food processor shaft 158 may include connection points at both ends, including the first end which connects securely to the first food processor bushing 156, and the second end which connects to the second food processor bushing 160, for efficient power transfer throughout the food processor unit 110.

The integrated cooking appliance 100 also includes a food processor carafe 162 having an open end and a base end. An opening 164 is located in a center of the base end of the food processor carafe 162. The opening 164 is configured to receive the second food processor bushing 160. Herein, the first end of the food processor shaft 158 is configured to pass through the open end and insert through the first food processor bushing 156 into a central opening of the food processor blade 146.

The food processor carafe 162 serves as the container for holding food items during processing operations and collecting the processed food after cutting, slicing, or dicing. The food processor carafe 162 is designed with appropriate dimensions to collect all processed food that passes through the food processor blade 146, with sufficient volume to accommodate typical processing quantities. The food processor carafe 162 may be constructed from durable, clear glass that allows users to monitor the food processing progress visually, ensuring the desired quantity and consistency are achieved. The food processor carafe 162 may incorporate measurement markings on its exterior to assist users in tracking quantities of processed food, enhancing recipe accuracy. The opening 164 is located in the center of the base end of the food processor carafe 162 and is specifically adapted to receive the second food processor bushing 160, creating a secure connection point while allowing rotational movement.

The integrated cooking appliance 100 also includes a cooking pan 166 configured to fit over the heating element 114. Herein, the heating element 114 is electrically connected to a first switch of a plurality of selectable switches. A thermally resistant handle 172 is configured to attach to a side of the cooking pan 166. The integrated cooking appliance 100 further includes a plurality of cooking pan lids 174. Each cooking pan lid 174 is configured to cover the cooking pan 166 during cooking.

The cooking pan 166 is a cookware component adapted to fit over the heating element 114 of the integrated cooking appliance 100. The cooking pan 166 may be designed with a flat bottom surface that maximizes contact with the heating element 114, ensuring efficient heat transfer and even cooking of food items. In an non-limiting example, the cooking pan 166 is constructed from stainless steel with appropriate thickness to provide optimal heat distribution while preventing warping under high temperatures. The heating element 114 is electrically connected to the first switch of the plurality of selectable switches (not shown), creating the control interface for the cooking unit 112. The first switch receives user input regarding desired heating levels and transmits appropriate electrical signals to the heating element 114 to achieve and maintain the selected temperature. The thermally resistant handle 172 is configured to attach securely to a side of the cooking pan 166, providing a gripping point for handling the pan during hot cooking operations. The thermally resistant handle 172 is constructed from heat-resistant rubber that remains cool to the touch even when the cooking pan 166 is at maximum operating temperature and is ergonomically designed to provide a comfortable grip that accommodates various hand sizes and gripping styles. The plurality of cooking pan lids 174 provides various covering options for the cooking pan 166 during different cooking operations. Each cooking pan lid 174 is dimensioned to create a proper seal with a rim of the cooking pan 166, containing heat and moisture as required for different cooking techniques.

In an aspect of the present disclosure, the cooking pan 166 and the plurality of cooking pan lids 174 are coated with polytetrafluoroethylene. The polytetrafluoroethylene coating creates a non-stick surface on both the cooking pan 166 and the plurality of cooking pan lids 174, preventing food adhesion during cooking and facilitating easy cleaning after use. The polytetrafluoroethylene coating is configured to withstand the high temperatures reached during typical cooking operations without degrading or releasing harmful compounds, providing food safety.

Further, in an aspect, the cooking pan 166 and the plurality of cooking lids 174 include a solid lid configured with a steam hole and a slotted lid. The solid lid (not shown) provides complete coverage of the cooking pan 166, containing heat and moisture for cooking operations that benefit from retained heat and moisture. The solid lid includes the steam hole that allows controlled release of excess steam pressure, preventing buildup that could lead to boiling over while maintaining sufficient moisture for proper cooking. The slotted lid may have multiple openings that enable moisture to be released while retaining heat, ideal for cooking techniques that require reducing liquids or achieving slightly drier results than would be possible with the solid lid. Both the solid lid and slotted lid are dimensioned to create a proper seal with the cooking pan 166, with sufficient weight that helps maintain positioning during cooking while remaining easy to lift and reposition when necessary.

The integrated cooking appliance 100 also includes a blender handle 182 connected to the blender carafe 130 and a food processor handle 184 connected to the food processor carafe 162. Herein, the blender handle 182, the food processor handle 184 and the thermally resistant handle 172 are rubber. The blender handle 182 is securely connected to the blender carafe 130, providing a comfortable gripping surface for handling the blender carafe 130 during positioning, removal, and pouring operations. The blender handle 182 is constructed from the rubber material to provide grip even when hands are wet. The blender handle 182 is ergonomically designed with contours that accommodate various hand sizes and gripping positions, enhancing usability for different users. The food processor handle 184 is connected to the food processor carafe 162, providing a secure gripping surface for handling the food processor carafe 162 during positioning, removal, and content transfer operations. The food processor handle 184 is constructed from the same rubber material as the blender handle 182, providing consistent tactile experience and performance across the integrated cooking appliance 100. The food processor handle 184 is ergonomically designed to provide a comfortable grip while supporting the potentially substantial weight of the food processor carafe 162 and its processed contents. The use of rubber material for the blender handle 182, the food processor handle 184, and the thermally resistant handle 172 creates a uniform tactile and visual experience throughout the integrated cooking appliance 100. The rubber material is selected for its combination of grip security, comfort, durability, and heat resistance, providing optimal performance across all handle applications in the integrated cooking appliance 100.

The integrated cooking appliance 100 also includes a layer of thermal insulation 186 located within the second side 104b of the appliance base 102 below the heating element 114. The integrated cooking appliance 100 further includes a first non-slip mat 188 configured to cover a lower surface of the appliance base 102. The layer of thermal insulation 186 serves to contain heat within the cooking area while protecting the supporting surface and internal components from excessive heat transfer. The thermal insulation 186 is constructed from high-temperature resistant materials capable of withstanding the maximum heat generated by the heating element 114 without degradation or release of harmful compounds. The first non-slip mat 188 provides a stable positioning during operation of the integrated cooking appliance 100. The first non-slip mat 188 is constructed from rubber material with a textured surface pattern that creates high friction against typical countertop materials, preventing sliding or shifting even during blending or food processing operations. The first non-slip mat 188 also provides electrical insulation between the integrated cooking appliance 100 and the supporting surface, adding an additional layer of safety protection in the kitchen environment.

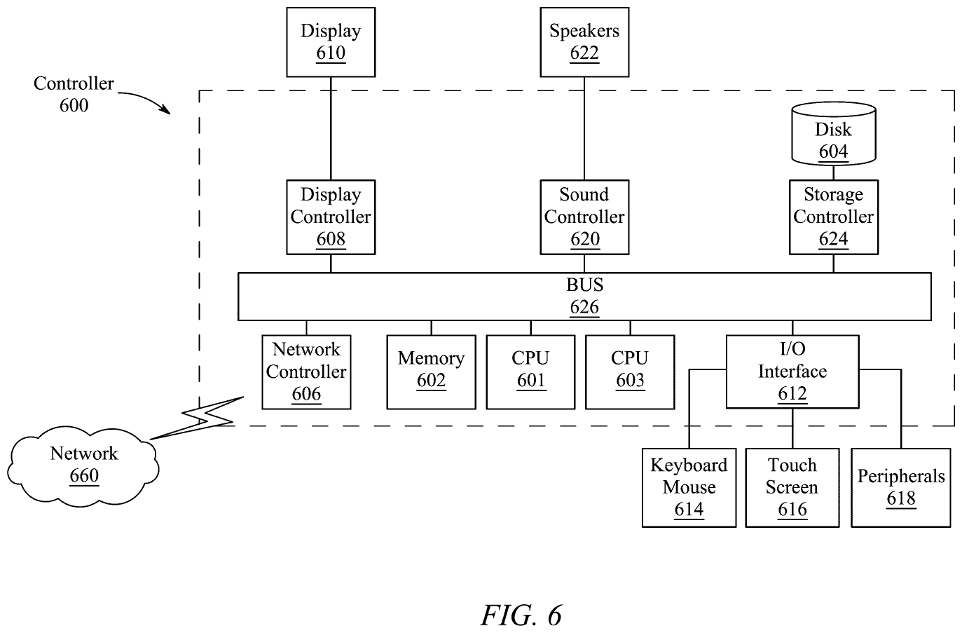

The integrated cooking appliance 100 also includes a circuit board including a microprocessor (illustratively described later in reference to FIGS. 6-9) located in the upper compartment 134 within the central portion 134a The integrated cooking appliance 100 further includes a plurality of selectable switches (not shown) located in the second portion 134c. Herein, the plurality of selectable switches are operatively connected to the microprocessor. The integrated cooking appliance 100 further includes a plurality of selectable buttons 190 located within the removable cover 148. The plurality of selectable buttons 190 are capacitively connected to the plurality of selectable switches.

The circuit board is the primary electronic control component of the integrated cooking appliance 100, housing the microprocessor and associated circuitry that manages all electronic functions. The circuit board is located in the upper compartment 134 within the central portion 134a, positioning it centrally within the appliance for efficient connection to all electronic subsystems. The circuit board is designed with appropriate circuitry to process user inputs from the plurality of selectable switches and convert those inputs into control signals for the various functional components of the integrated cooking appliance 100. The microprocessor is the central processing unit of the integrated cooking appliance 100, coordinating all electronic functions and processing user inputs to control the various operational systems. The microprocessor is programmed with firmware that manages the operational logic of the appliance, including timing functions, temperature control for the heating element 114, and motor speed control for both the blender motor 118 and the food processor motor 122. The microprocessor receives input signals from the plurality of selectable switches and processes these signals according to its programming to activate the appropriate appliance functions.

The plurality of selectable switches are located in the second portion 134c of the upper compartment 134 and serve as the electrical interface between user inputs and the circuit board. Each switch in the plurality is designed to activate a specific function of the integrated cooking appliance 100, converting physical button presses into electrical signals that the microprocessor can interpret and process. The plurality of selectable buttons 190 are located within the removable cover 148 and serve as the physical interface that users interact with to control the integrated cooking appliance 100. Each of the plurality of selectable buttons 190 is positioned above a corresponding switch in the plurality of selectable switches. The plurality of selectable buttons 190 are capacitively connected to the plurality of selectable switches, eliminating the need for physical penetrations through the removable cover 148.

In an aspect of the present disclosure, the plurality of selectable buttons 190 includes: an ON/OFF button 192 capacitively connected to an ON/OFF switch; a food processing button 194 capacitively connected to a food processor switch; a blending button 196 capacitively connected to a blender switch; and a heating button 198 capacitively connected to a heater switch. The ON/OFF button 192 is the primary power control interface for the integrated cooking appliance 100, allowing users to activate or deactivate the entire system. The food processing button 194 activates the food processor unit 110, initiating operation of the food processor motor 122 and associated components. The blending button 196 activates the blender unit 106, initiating operation of the blender motor 118 and associated components. The heating button 198 activates the cooking unit 112, initiating operation of the heating element 114 and associated components. The buttons 192, 194, 196, 198 are capacitively connected to the corresponding switches. The buttons 192, 194, 196, 198 are positioned in logical proximity to respective control mechanisms. The buttons 192, 194, 196, 198 may also incorporate visual feedback mechanisms that indicate when the corresponding function is active, enhancing user awareness of system status in the integrated cooking appliance 100.

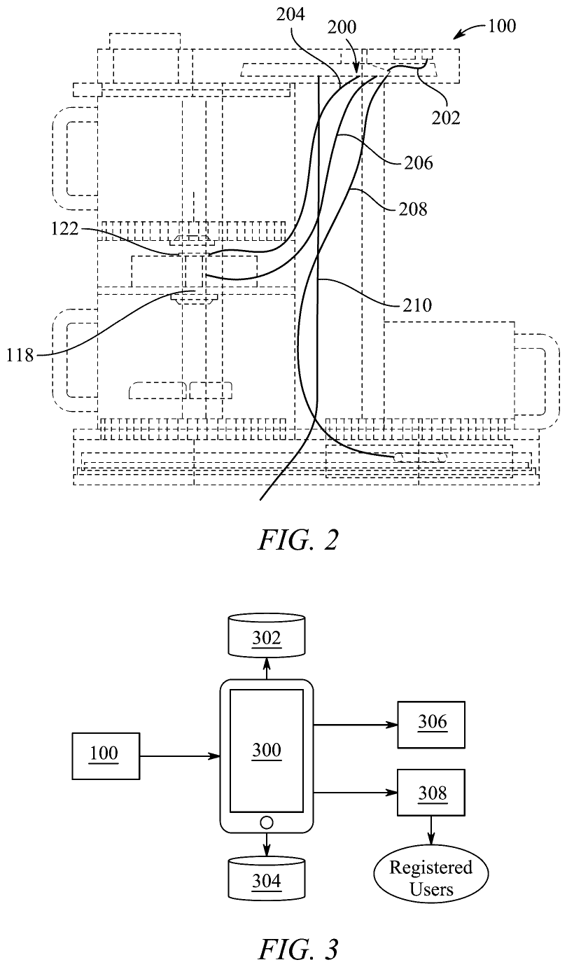

Referring now to FIG. 2, as illustrated, the integrated cooking appliance 100 also includes a wiring harness 200 connected to the plurality of selectable switches. Herein, the wiring harness 200 includes: a first wire 202 configured to connect the ON/OFF switch to the microprocessor; a second wire 204 configured to connect the food processor switch to the food processor motor 122; a third wire 206 configured to connect the blender switch to the blender motor 118; a fourth wire 208 configured to connect the heater switch to the heating element 114; and a fifth wire 210 configured to connect the circuit board to a power source. The wiring harness 200 is a structured assembly with appropriate wire gauges for each connection, protective sheathing against internal structures, and secure connection points with locking mechanisms. The first wire 202, which connect the ON/OFF switch to the microprocessor, enables power control of the entire system. The second wire 204, which connects the food processor switch to the food processor motor 122, enables control of the food processing function. The third wire 206, which connects the blender switch to the blender motor 118, enables control of the blending function. The fourth wire 208, which connect the heater switch to the heating element 114, enables control of the cooking function. The fifth wire 210, which connects the circuit board to the power source, provides primary electrical input. Each wire is specifically designed with appropriate insulation and routing paths to efficiently deliver power while ensuring safety, durability, and reliable operation.

Referring now to FIG. 3, a schematic diagram of a savor moment computing application 300 is illustrated. The integrated cooking appliance 100 includes the savor moment computing application 300 registered to a user of the integrated cooking appliance 100. The integrated cooking appliance 100 communicates with the savor moment computing application 300 via a wireless connection. The savor moment computing application 300 operates on standard smartphones, tablets, or personal computing devices, creating an interface for controlling features of the integrated cooking appliance 100 and accessing cooking content. The savor moment computing application 300 includes a registration database 302 configured to store an identification number of the integrated cooking appliance 100. The registration database 302 establishes a connection between the specific integrated cooking appliance 100 and the registered user. The savor moment computing application 300 further includes a recipe database 304 accessible by the user of the savor moment computing application 300. The recipe database 304 contains recipes specifically optimized for the integrated cooking appliance 100. The recipe database 304 allows users to search and filter recipes based on ingredients, preparation time, meal type, and dietary preferences. The savor moment computing application 300 further includes a personalized recipe memory 306 configured to store favorite recipes and to receive recipes entered by the user. The personalized recipe memory 306 enables users to save recipes from the recipe database 304 as favorites for quick access. The savor moment computing application 300 further includes a sharing interface 308 configured to connect registered users with one another to share recipes. The sharing interface 308 connects the user with other registered users of the savor moment computing application 300 and provides mechanisms for users to share recipes from either the recipe database 304 or the personalized recipe memory 306 with connected users. Thereby, the savor moment computing application 300 extends the functionality of the integrated cooking appliance 100 by providing digital recipe access, storage capabilities, and connectivity features. The savor moment computing application 300 creates a cooking system with the integrated cooking appliance 100, integrating physical cooking functionality with digital recipe management and social sharing capabilities.

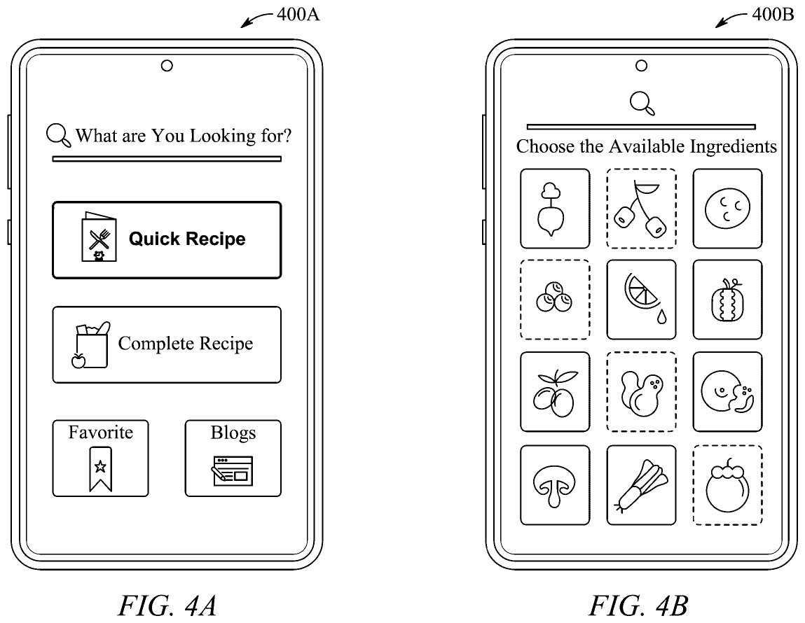

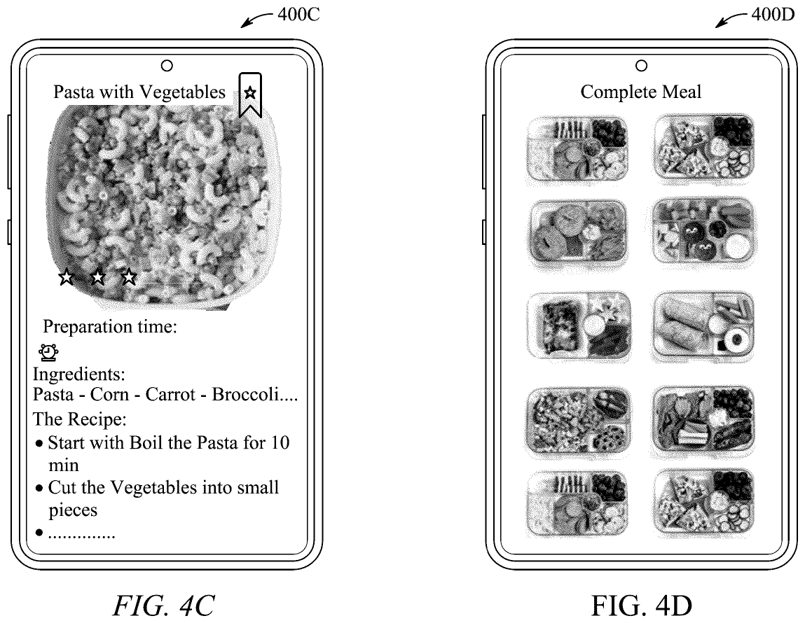

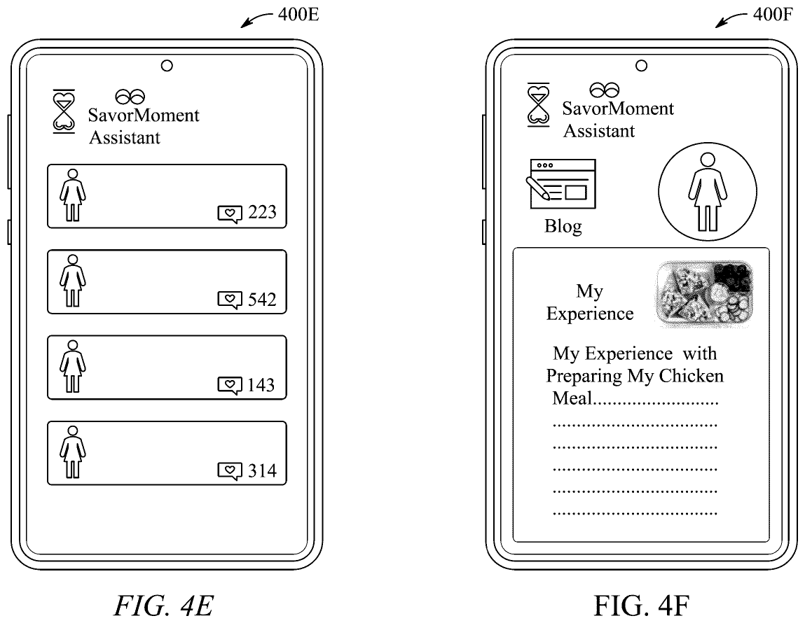

Referring now to FIGS. 4A-4E, a first series of display interfaces of the savor moment computing application 300 is illustrated. FIG. 4A shows an interface 400A of the savor moment computing application 300 displaying selectable function options for the integrated cooking appliance 100. The interface 400A includes selection buttons for Quick Recipes, Complete Recipes, and Favorite functions. FIG. 4B shows an interface 400B of the savor moment computing application 300 displaying functional icons for food preparation operations that can be performed with the integrated cooking appliance 100. The interface 400B includes selectable icons representing different cooking methods available on the integrated cooking appliance 100. FIG. 4C shows an interface 400C of the savor moment computing application 300 displaying recipe information including ingredients and preparation steps. The interface 400C shows a specific recipe with detailed instructions formatted for the integrated cooking appliance 100. FIG. 4D shows an interface 400D of the savor moment computing application 300 displaying recipe thumbnail images. The interface 400D presents visual representations of recipes stored in the recipe database 304 for selection by the user. FIG. 4E shows an interface 400E of the savor moment computing application 300 displaying user account information and registered appliance data. FIG. 4F shows an interface 400F of the savor moment computing application 300 displaying a community blog section. The interface 400F enables users to post and view cooking experiences related to recipes prepared with the integrated cooking appliance 100.

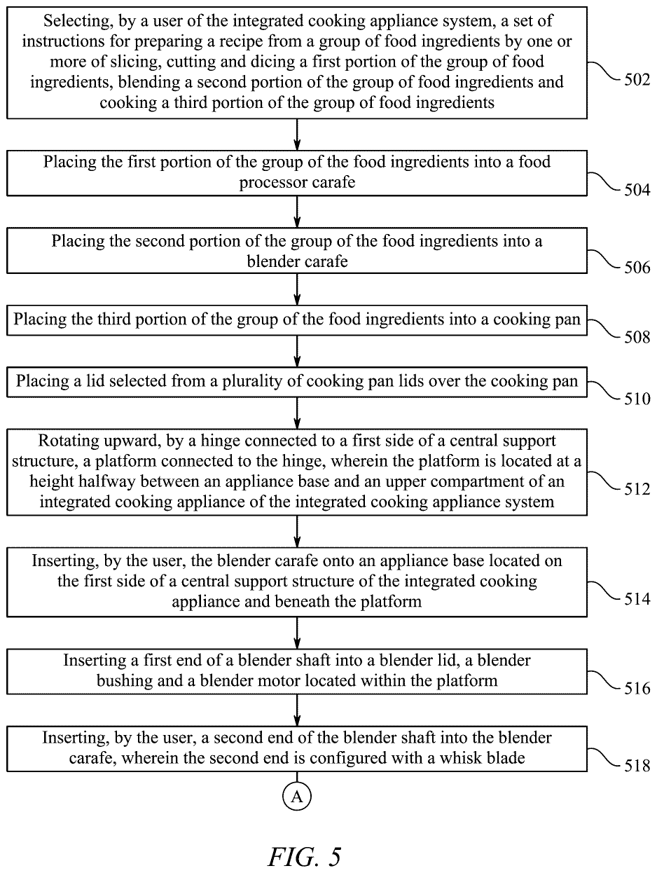

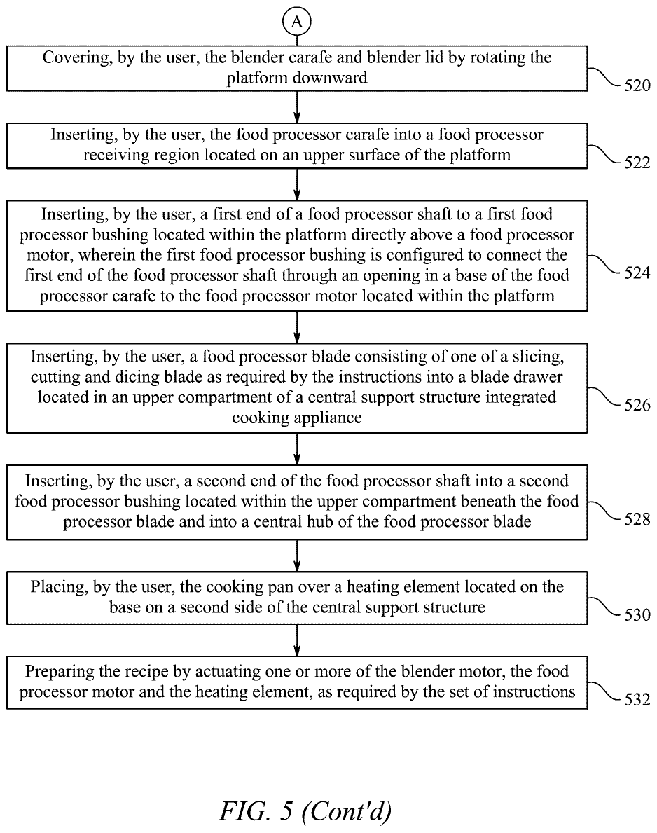

Referring now to FIG. 5, a flowchart of a method (as represented by reference numeral 500) of using the integrated cooking appliance 100 is illustrated. The method 500 includes a series of steps. These steps are only illustrative, and other alternatives may be considered where one or more steps are added, one or more steps are removed, or one or more steps are provided in a different sequence without departing from the scope of the present disclosure. Various variants described above, with respect to the aforementioned integrated cooking appliance 100 apply mutatis mutandis to the present method 500.

At step 502, the method 500 includes selecting, by a user of the integrated cooking appliance system, a set of instructions for preparing a recipe from a group of food ingredients. The set of instructions may direct the user to perform preparation steps including one or more of slicing, cutting and dicing a first portion of the group of food ingredients, blending a second portion of the group of food ingredients and cooking a third portion of the group of food ingredients. The user reviews recipe options from the savor moment computing application 300 and chooses a recipe that requires multiple preparation techniques available on the integrated cooking appliance 100. The selection process involves identifying appropriate ingredients and determining which portions will be processed by each functional unit of the integrated cooking appliance 100.

At step 504, the method 500 includes placing the first portion of the group of the food ingredients into the food processor carafe 162. The user adds vegetables, fruits, or other solid food items requiring processing into the food processor carafe 162. The food processor carafe 162 is positioned to receive ingredients that will be sliced, diced, or chopped based on the selected recipe requirements.

At step 506, the method 500 includes placing the second portion of the group of the food ingredients into the blender carafe 130. The user adds liquid ingredients or soft food items requiring blending into the blender carafe 130. The blender carafe 130 is designed to contain ingredients that will be mixed, pureed, or emulsified according to the recipe specifications.

At step 508, the method 500 includes placing the third portion of the group of the food ingredients into the cooking pan 166. The user adds ingredients requiring heating or cooking into the cooking pan 166. The cooking pan 166 is positioned on the cooking unit 112 to receive ingredients that will be heated, sautéed, or simmered according to the recipe.

At step 510, the method 500 includes placing a lid selected from the plurality of cooking pan lids 174 over the cooking pan 166. The user selects either the solid lid or the slotted lid based on the cooking technique required. The selected lid creates appropriate cooking conditions by either retaining or releasing moisture during the cooking process.

At step 512, the method 500 includes rotating upward, by a hinge connected to the first side 104a of the central support structure 104, the platform 108 connected to the hinge, in which the platform 108 is located at a height halfway between the appliance base 102 and the upper compartment 134 of the integrated cooking appliance 100 of the integrated cooking appliance system. The user lifts the platform 108 to create access to the blender unit 106 located beneath the platform 108. The rotation exposes the mounting area for the blender carafe 130.

At step 514, the method 500 includes inserting, by the user, the blender carafe 130 onto the appliance base 102 located on the first side of the central support structure 104 of the integrated cooking appliance 100 and beneath the platform 108. The user places the blender carafe 130 in the designated position on the appliance base 102. The blender carafe 130 is aligned with connection points for the blender shaft 120.

At step 516, the method 500 includes inserting a first end of the blender shaft 120 into the blender lid 132, the blender bushing 126 and the blender motor 118 located within the platform 108. The user aligns the blender shaft 120 through the opening in the blender lid 132 and into connection with the blender bushing 126. The blender shaft 120 establishes a mechanical connection with the blender motor 118 to enable power transfer.

At step 518, the method 500 includes inserting, by the user, a second end of the blender shaft 120 into the blender carafe 130, in which the second end is configured with the whisk blade 128. The user ensures the whisk blade 128 is properly positioned within the contents of the blender carafe 130. The whisk blade 128 is positioned to effectively blend the ingredients when activated.

At step 520, the method 500 includes covering, by the user, the blender carafe 130 and blender lid 132 by rotating the platform 108 downward. The user lowers the platform 108 back to its horizontal position. The platform 108 secures the blender lid 132 in place and establishes the proper operating configuration for blending.

At step 522, the method 500 includes inserting, by the user, the food processor carafe 162 into a food processor receiving region located on an upper surface of the platform 108. The user places the food processor carafe 162 into the designated mounting location. The food processor carafe 162 is positioned to align with the food processor components in the platform 108 and the upper compartment 134.

At step 524, the method 500 includes inserting, by the user, a first end of the food processor shaft 158 to a first food processor bushing 156 located within the platform 108 directly above the food processor motor 122, in which the first food processor bushing 156 is configured to connect the first end of the food processor shaft 158 through the opening 164 in the base of the food processor carafe 162 to the food processor motor 122 located within the platform 108. The user aligns the food processor shaft 158 with the connection system in the platform 108. The food processor shaft 158 establishes a mechanical link between the food processor motor 122 and the food processing components.

At step 526, the method 500 includes inserting, by the user, the food processor blade 146 consisting of one of a slicing, cutting and dicing blade as required by the instructions into the blade drawer located in the upper compartment 134 of the central support structure 104 of the integrated cooking appliance 100. The food processor blade 146 has a blade handle 144. The user selects the appropriate food processor blade 146 based on the required food processing technique. The blade handle 144 secures and positions the selected food processor blade 146 for operation.

At step 528, the method 500 includes inserting, by the user, a second end of the food processor shaft 158 into the second food processor bushing 160 located within the upper compartment 134 beneath the food processor blade 146 and into a central hub of the food processor blade 146. The user completes the mechanical connection between the food processor shaft 158 and the food processor blade 146. The connection enables rotational force to be transmitted from the food processor motor 122 to the food processor blade 146.

At step 530, the method 500 includes placing, by the user, the cooking pan 166 over the heating element 114 located on the base 102 on the second side 104b of the central support structure 104. The user positions the cooking pan 166 on the designated cooking surface. The cooking pan 166 is placed to establish thermal contact with the heating element 114 for effective heat transfer.

At step 532, the method 500 includes preparing the recipe by actuating one or more of the blender motor 118, the food processor motor 122 and the heating element 114, as required by the set of instructions. The user activates the appropriate functions through the plurality of selectable buttons 190 on the integrated cooking appliance 100. The food preparation proceeds according to the recipe requirements with simultaneous or sequential operation of the different functional units.

The method 500 further includes connecting, by the user, the blender handle 182 to the blender carafe 130; connecting, by the user, the food processor handle 184 to the food processor carafe 162; and connecting, by the user, the thermally resistant cooking pan handle 172 to the cooking pan 166. The user attaches the appropriate handles to each container component for safe handling. The handles provide heat-resistant gripping surfaces that enable secure manipulation of the containers during food preparation.

The method 500 further includes connecting, by the user, an electrical plug of the integrated cooking appliance 100 to an electrical source; turning the integrated cooking appliance 100 ON by pressing the ON/OFF button 192 of the integrated cooking appliance 100; and performing, by the user, one or more of: actuating the food processor motor 122 by pressing the food processing button 194, actuating the blender motor 118 by pressing the blending button 196, and actuating the heating element 114 by pressing the heating button 198. The user establishes electrical power to the integrated cooking appliance 100 and activates the main power function. The user then selectively operates the specific functional components as required by the recipe sequence.

The method 500 further includes downloading, to a smartphone of the user of the integrated cooking appliance 100, the savor moment computing application 300 associated with the integrated cooking appliance 100; registering, by the user, the smartphone to the savor moment computing application 300; and selecting, by the user, the recipe from the recipe database 304 accessible by the savor moment computing application 300, in which the selected recipe includes the set of instructions for preparing the recipe. The user installs the digital application that enhances functionality of the integrated cooking appliance 100. The user creates a digital connection between the smartphone and the integrated cooking appliance 100 through the registration process. The user accesses the expanded recipe options available through the digital platform.

The method 500 further includes saving, by the user, the selected recipe to a memory of the savor moment computing application 300 as a favorite; connecting, by the user, with other users of the savor moment computing application 300; and blogging, by the user, with the other users. The user creates a personalized collection of preferred recipes within the digital application. The user establishes connections with a community of users who also own the integrated cooking appliance 100. The user shares experiences and recipe modifications through digital communication channels provided by the savor moment computing application 300.

The integrated cooking appliance 100 and the method 500 of the present disclosure provide a comprehensive solution for food preparation that combines multiple cooking functions in a single, space-efficient unit. The integrated cooking appliance 100 incorporates the blender unit 106, the food processor unit 110, and the cooking unit 112 arranged around the central support structure 104, enabling users to perform various food preparation tasks including blending, food processing, and cooking within a unified device. The arrangement of the platform 108 hingeably connected to the first side 104a of the central support structure 104, with the platform 108 positioned above the blender unit 106 and supporting the food processor unit 110, creates a vertical stacking configuration that optimizes counter space utilization. The integration with the savor moment computing application 300 further extends functionality beyond physical capabilities through digital connectivity for recipe management and social sharing.

The integrated cooking appliance 100 reduces kitchen counter space requirements by eliminating the need for separate blenders, food processors, and cooking devices. The integrated cooking appliance 100 enables simultaneous preparation of different meal components, allowing users to blend ingredients in the blender unit 106, process vegetables in the food processor unit 110, and cook food in the cooking unit 112 without transferring between multiple appliances. The dual motor 116 arrangement with coaxial configuration of the blender motor 118 and the food processor motor 122 provides efficient power delivery while minimizing the size and complexity of the motor system. The interchangeable food processor blades 146 including the cutting blade, dicing blade, and chopping blade allow for versatile food processing capabilities within a single appliance. The savor moment computing application 300 offers enhanced recipe access through the recipe database 304, personalized storage through the personalized recipe memory 306, and community engagement through the sharing interface 308, creating an ecosystem around the integrated cooking appliance 100 that extends usability beyond standalone appliances.

The method 500 of using the integrated cooking appliance system 100 provides a workflow for preparing complete meals by enabling a coordinated sequence of food preparation steps within a single appliance. The method 500 reduces the number of distinct appliances that may need to be operated, cleaned, and stored, creating efficiency improvements in kitchen operations. The integrated approach of the method 500 allows users to maintain a cleaner cooking environment with fewer transfers between devices. The incorporation of digital support through the savor moment computing application 300 provides access to optimized recipes, storage of personal recipe collections, and community feedback that enhances the cooking process and results. Such integration of physical cooking capabilities with digital support features creates a cooking system that addresses multiple aspects of meal preparation from ingredient processing to recipe management and sharing.

A first embodiment describes an integrated cooking appliance 100, comprising: an appliance base 102; a central support structure 104 located on the appliance base 102; a blender unit 106 located on the appliance base 102 and connected to a first side 104a of the central support structure 104; a platform 108 hingeably connected to the first side 104a of the central support structure 104, wherein the platform 108 is located above the blender unit 106; a food processor unit 110 located on the platform 108 above the blender unit 106; and a cooking unit 112 located on the appliance base 102 and connected to a second side 104b of the central support structure 104, wherein the cooking unit 112 comprises a heating element 114 located within the appliance base 102 on the second side 104b.

In an aspect, the integrated cooking appliance 100, further comprises: a dual motor 116 located within the platform 108, wherein the dual motor 116 includes a blender motor 118 having a blender shaft 120 and a food processor motor 122 having a food processor motor shaft 124, wherein the blender motor 118, the blender shaft 120, the food processor motor 122 and the food processor motor shaft 124 are coaxial; a blender bushing 126 located within the platform 108 directly beneath the blender motor 118, wherein the blender bushing 126 is configured to connect a first end of the blender shaft 120 to the blender motor 118; a whisk blade 128 connected to a second end of the blender shaft 120; a blender carafe 130; and a blender carafe lid 132 having an opening configured to receive the blender shaft 120.

In an aspect, the integrated cooking appliance 100, further comprises: an upper compartment 134 located on the central support structure 104, wherein the upper compartment 134 comprises a central portion 134a located directly over the central support structure 104, a first portion 134b configured to extend over the first side 104a and a second portion 134c configured to extend at least partially over the second side 104b; a food chute 142 located within the first portion 134b of the upper compartment 134; a blade drawer for receiving a food processor blade 146, wherein the blade drawer is located within the first portion 134b below the food chute 142; and a removable cover 148 located on a top surface of the integrated cooking appliance 100.

In an aspect, the food processor blade 146 is selected from a set of food processor blades, comprising: a cutting blade; a dicing blade; and a chopping blade, wherein the food processor blade 146 is configured to one of dice, slice and chop food inserted into the food chute 142 located in the removable cover 148 of the food processor unit 110.

In an aspect, the integrated cooking appliance 100, further comprises: a first food processor bushing 156 located within the platform 108 directly above the food processor motor 122, wherein the first food processor bushing 156 is configured to connect a first end of a food processor shaft 158 to the food processor motor shaft 124; and a second food processor bushing 160 located within the second portion 134c beneath the food processor blade 146, wherein the second food processor bushing 160 is configured to rotatably attach a second end of the food processor shaft 158 to a central hub of a selected food processor blade 146.

In an aspect, the integrated cooking appliance 100, further comprises: a food processor carafe 162 having an open end and a base end; and an opening 164 located in a center of the base end of the food processor carafe 162, wherein the opening 164 is configured to receive the second food processor bushing 160, wherein the first end of the food processor shaft 158 is configured to pass through the open end and insert through the first food processor bushing 156 into a central opening of the food processor blade 146.

In an aspect, the integrated cooking appliance 100, further comprises: a cooking pan 166 configured to fit over the heating element 114, wherein the heating element 114 is electrically connected to a first switch of a plurality of selectable switches; a thermally resistant handle 172 configured to attach to a side of the cooking pan 166; and a plurality of cooking pan lids 174, wherein each cooking pan lid 174 is configured to cover the cooking pan 166 during cooking.

In an aspect, the cooking pan 166 and the plurality of cooking pan lids 174 are coated with polytetrafluoroethylene.

In an aspect, the cooking pan 166 and the plurality of cooking lids 174 include a solid lid configured with a steam hole and a slotted lid.

In an aspect, the integrated cooking appliance 100, further comprises: a blender handle 182 connected to the blender carafe 130; and a food processor handle 184 connected to the food processor carafe 162, wherein the blender handle 182, the food processor handle 184 and the thermally resistant handle 172 are rubber.

In an aspect, the integrated cooking appliance 100, further comprises: a circuit board including a microprocessor located in the upper compartment 134 within the central portion 134a; a plurality of selectable switches located in the second portion 134c, wherein the plurality of selectable switches are operatively connected to the microprocessor; and a plurality of selectable buttons 190 located within the removable cover 148, wherein the plurality of selectable buttons 190 are capacitively connected to the plurality of selectable switches.

In an aspect, the plurality of selectable buttons 190 includes: an ON/OFF button 192 capacitively connected to an ON/OFF switch; a food processing button 194 capacitively connected to a food processor switch; a blending button 196 capacitively connected to a blender switch; and a heating button 198 capacitively connected to a heater switch.

In an aspect, the integrated cooking appliance 100, further comprises: a wiring harness 200 connected to the plurality of selectable switches, wherein the wiring harness 200 includes: a first wire 202 configured to connect the ON/OFF switch to the microprocessor; a second wire 204 configured to connect the food processor switch to the food processor motor 122; a third wire 206 configured to connect the blender switch to the blender motor 118; a fourth wire 208 configured to connect the heater switch to the heating element 114; and a fifth wire 210 configured to connect the circuit board to a power source.

In an aspect, the integrated cooking appliance 100, further comprises: a layer of thermal insulation 186 located within the second side 104b of the appliance base 102 below the heating element 114; and a first non-slip mat 188 configured to cover a lower surface of the appliance base 102.

In an aspect, the integrated cooking appliance 100, further comprises: a savor moment computing application 300 registered to a user of the integrated cooking appliance 100, wherein the savor moment computing application 300 includes: a registration database 302 configured to store an identification number of the integrated cooking appliance 100; a recipe database 304 accessible by the user of the savor moment computing application 300; a personalized recipe memory 306 configured to store favorite recipes and to receive recipes entered by the user; and a sharing interface 308 configured to connect registered users with one another to share recipes.

A second embodiment describes a method 500 of using an integrated cooking appliance system, comprising: selecting, by a user of the integrated cooking appliance system, including a set of instructions for preparing a recipe from a group of food ingredients by one or more of slicing, cutting and dicing a first portion of the group of food ingredients, blending a second portion of the group of food ingredients and cooking a third portion of the group of food ingredients; placing the first portion of the group of the food ingredients into a food processor carafe 162; placing the second portion of the group of the food ingredients into a blender carafe 130; placing the third portion of the group of the food ingredients into a cooking pan 166; placing a lid selected from a plurality of cooking pan lids 174 over the cooking pan 166; rotating upward, by a hinge connected to a first side 104a of a central support structure 104, a platform 108 connected to the hinge, wherein the platform 108 is located at a height halfway between an appliance base 102 and an upper compartment 134 of an integrated cooking appliance 100 of the integrated cooking appliance system; inserting, by the user, the blender carafe 130 onto an appliance base 102 located on the first side 104a of a central support structure 104 of the integrated cooking appliance 100 and beneath the platform 108; inserting a first end of a blender shaft 120 into a blender lid 132, a blender bushing 126 and a blender motor 118 located within the platform 108; inserting, by the user, a second end of the blender shaft 120 into the blender carafe 130, wherein the second end is configured with a whisk blade 128; covering, by the user, the blender carafe 130 and blender lid 132 by rotating the platform 108 downward; inserting, by the user, the food processor carafe 162 into a food processor receiving region located on an upper surface of the platform 108; inserting, by the user, a first end of a food processor shaft 158 to a first food processor bushing 156 located within the platform 108 directly above a food processor motor 122, wherein the first food processor bushing 156 is configured to connect the first end of the food processor shaft 158 through an opening 164 in a base of the food processor carafe 162 to the food processor motor 122 located within the platform 108; inserting, by the user, a food processor blade 146 consisting of one of a slicing, cutting and dicing blade as required by the instructions into a blade drawer located in an upper compartment 134 of a central support structure 104 integrated cooking appliance 100; inserting, by the user, a second end of the food processor shaft 158 into a second food processor bushing 160 located within the upper compartment 134 beneath the food processor blade 146 and into a central hub of the food processor blade 146; placing, by the user, the cooking pan 166 over a heating element 114 located on the base 102 on a second side 104b of the central support structure 104; and preparing the recipe by actuating one or more of the blender motor 118, the food processor motor 122 and the heating element 114, as required by the set of instructions.

In an aspect, the method 500, further comprises: connecting, by the user, a blender handle 182 to the blender carafe 130; connecting, by the user, a food processor handle 184 to the food processor carafe 162; and connecting, by the user, a thermally resistant cooking pan handle 172 to the cooking pan 166.

In an aspect, the method 500, further comprises: connecting, by the user, an electrical plug of the integrated cooking appliance 100 to an electrical source; turning the integrated cooking appliance 100 ON by pressing an ON/OFF button 192 of the integrated cooking appliance 100; and performing, by the user, one or more of: actuating the food processor motor 122 by pressing a food processing button 194, actuating the blender motor 118 by pressing a blending button 196, and actuating the heating element 114 by pressing the heating button 198.

In an aspect, the method 500, further comprises: downloading, to a smartphone of a user of an integrated cooking appliance 100, a savor moment computing application 300 associated with the integrating cooking appliance 100; registering, by the user, the smartphone to the savor moment computing application 300; and selecting, by the user, the recipe from a recipe database 304 accessible by the savor moment computing application 300, wherein the selected recipe includes the set of instructions for preparing the recipe.

In an aspect, the method 500, further comprises: saving, by the user, the selected recipe to a memory of the savor moment computing application 300 as a favorite; connecting, by the user, with other users of the savor moment computing application 300; and blogging, by the user, with the other users.

Next, further details of the hardware description of the computing environment according to exemplary embodiments is described with reference to FIG. 6. In FIG. 6, a controller 600 is described embodying the control unit of the system of the present disclosure, in which the controller is a computing device which includes a CPU 601 which performs the processes described above/below. The process data and instructions may be stored in memory 602. These processes and instructions may also be stored on a storage medium disk 604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 601, 603 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 601 or CPU 603 may be a Xenon or Core processor from Intel of America or an Opteron processor from AMD of America or may be other processor types that would be recognized by one of ordinary skill in the art. Alternatively, the CPU 601, 603 may be implemented on an FPGA, ASIC, PLD or using discrete logic circuits, as one of ordinary skill in the art would recognize. Further, CPU 601, 603 may be implemented as multiple processors cooperatively working in parallel to perform the instructions of the inventive processes described above.

The computing device in FIG. 6 also includes a network controller 606, such as an Intel Ethernet PRO network interface card from Intel Corporation of America, for interfacing with network 660. As can be appreciated, the network 660 can be a public network, such as the Internet, or a private network such as an LAN or WAN network, or any combination thereof and can also include PSTN or ISDN sub-networks. The network 660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the computing device such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the computing device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

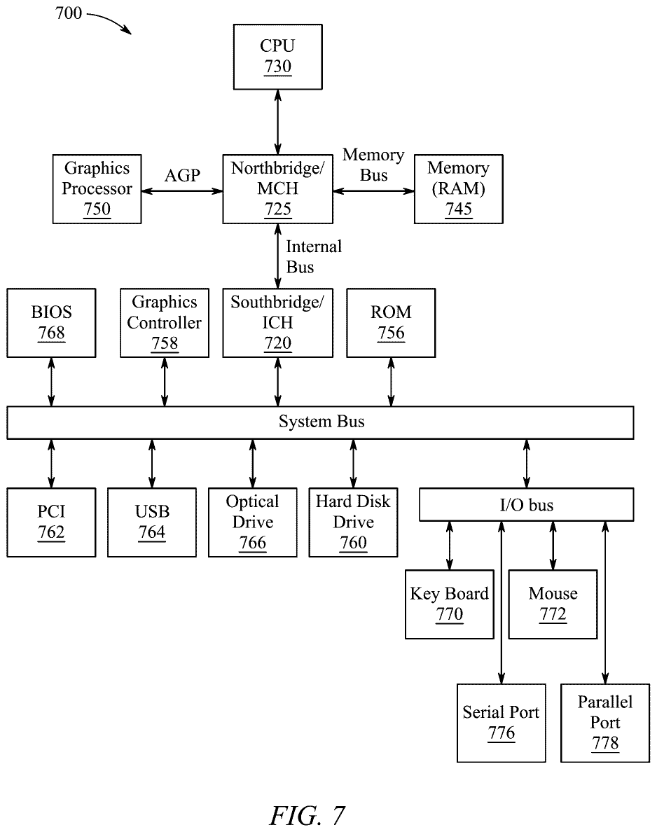

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 7.

FIG. 7 shows a schematic diagram of a data processing system, according to certain embodiments, for performing the functions of the exemplary embodiments. The data processing system is an example of a computer in which code or instructions implementing the processes of the illustrative embodiments may be located.

In FIG. 7, data processing system 700 employs a hub architecture including a north bridge and memory controller hub (NB/MCH) 725 and a south bridge and input/output (I/O) controller hub (SB/ICH) 720. The central processing unit (CPU) 730 is connected to NB/MCH 725. The NB/MCH 725 also connects to the memory 745 via a memory bus and connects to the graphics processor 750 via an accelerated graphics port (AGP). The NB/MCH 725 also connects to the SB/ICH 720 via an internal bus (e.g., a unified media interface or a direct media interface). The CPU Processing unit 730 may contain one or more processors and even may be implemented using one or more heterogeneous processor systems.

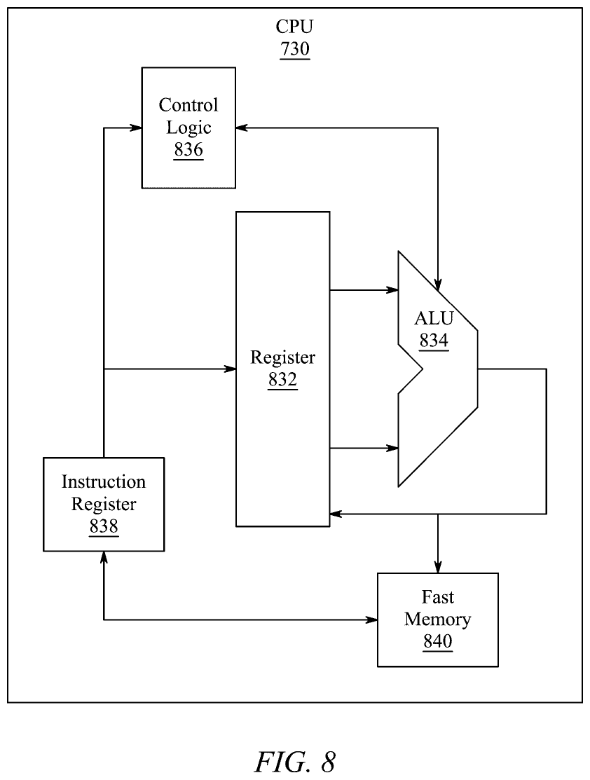

For example, FIG. 8 shows one implementation of CPU 730. In one implementation, the instruction register 838 retrieves instructions from the fast memory 840. At least part of these instructions are fetched from the instruction register 838 by the control logic 836 and interpreted according to the instruction set architecture of the CPU 730. Part of the instructions can also be directed to the register 832. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 834 that loads values from the register 832 and performs logical and mathematical operations on the loaded values according to the instructions. The results from these operations can be feedback into the register and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 7, the data processing system 700 can include that the SB/ICH 720 is coupled through a system bus to an I/O Bus, a read only memory (ROM) 756, universal serial bus (USB) port 764, a flash binary input/output system (BIOS) 768, and a graphics controller 758. PCI/PCIe devices can also be coupled to SB/ICH 788 through a PCI bus 762.

The PCI devices may include, for example, Ethernet adapters, add-in cards, and PC cards for notebook computers. The Hard disk drive 760 and CD-ROM 766 can use, for example, an integrated drive electronics (IDE) or serial advanced technology attachment (SATA) interface. In one implementation the I/O bus can include a super I/O (SIO) device.

Further, the hard disk drive (HDD) 760 and optical drive 766 can also be coupled to the SB/ICH 720 through a system bus. In one implementation, a keyboard 770, a mouse 772, a parallel port 778, and a serial port 776 can be connected to the system bus through the I/O bus. Other peripherals and devices that can be connected to the SB/ICH 720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

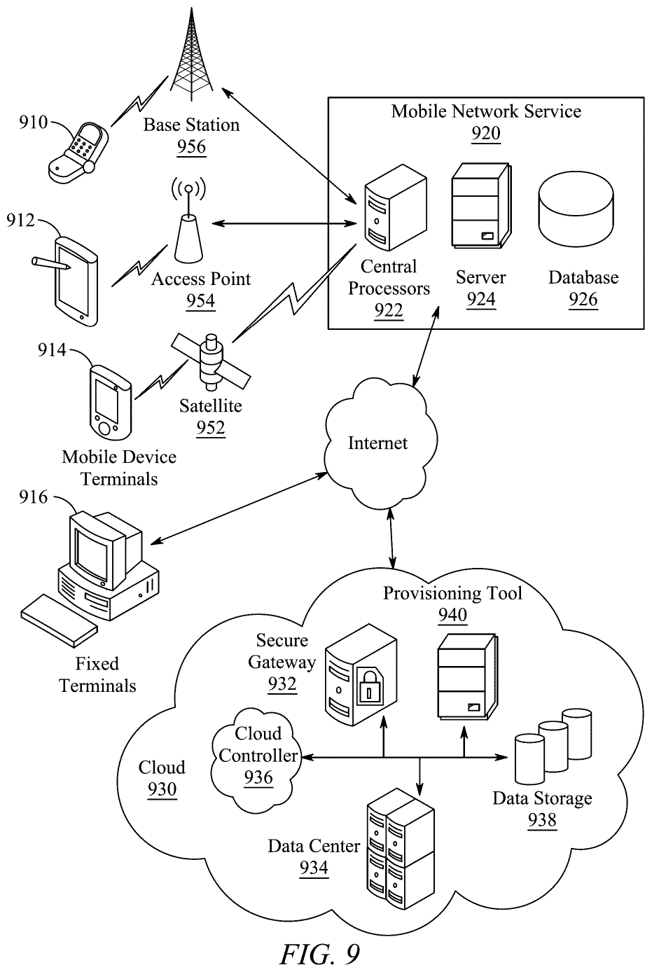

The functions and features described herein may also be executed by various distributed components of a system. For example, one or more processors may execute these system functions, wherein the processors are distributed across multiple components communicating in a network. The distributed components may include one or more client and server machines, such as cloud 930 including a cloud controller 936, a secure gateway 932, a data center 934, data storage 938 and a provisioning tool 940, and mobile network services 920 including central processors 922, a server 924 and a database 926, which may share processing, as shown by FIG. 9, in addition to various human interface and communication devices (e.g., display monitors 916, smart phones 910, tablets 912, personal digital assistants (PDAs) 914). The network may be a private network, such as a LAN, satellite 952 or WAN 954, or be a public network, may such as the Internet. Input to the system may be received via direct user input and received remotely in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An integrated cooking appliance, comprising:
an appliance base;
a central support structure located on the appliance base;
a blender unit located on the appliance base and connected to a first side of the central support structure;
a platform hingeably connected to the first side of the central support structure, wherein the platform is located above the blender unit;
a food processor unit located on the platform above the blender unit; and
a cooking unit located on the appliance base and connected to a second side of the central support structure, wherein the cooking unit comprises a heating element located within the appliance base on the second side.

2. The integrated cooking appliance of claim 1, further comprising:
a dual motor located within the platform, wherein the dual motor includes a blender motor having a blender shaft and a food processor motor having a food processor motor shaft, wherein the blender motor, the blender shaft, the food processor motor and the food processor motor shaft are coaxial;
a blender bushing located within the platform directly beneath the blender motor, wherein the blender bushing is configured to connect a first end of the blender shaft to the blender motor;
a whisk blade connected to a second end of the blender shaft;
a blender carafe; and
a blender carafe lid having an opening configured to receive the blender shaft.

3. The integrated cooking appliance of claim 2, further comprising:
an upper compartment located on the central support structure, wherein the upper compartment comprises a central portion located directly over the central support structure, a first portion configured to extend over the first side and a second portion configured to extend at least partially over the second side;
a food chute located within the first portion of the upper compartment;
a blade drawer for receiving a food processor blade, wherein the blade drawer is located within the first portion below the food chute; and
a removable cover located on a top surface of the integrated cooking appliance.

4. The integrated cooking appliance of claim 3, wherein the food processor blade is selected from a set of food processor blades, comprising:
a cutting blade;
a dicing blade; and
a chopping blade, wherein the food processor blade is configured to one of dice, slice and chop food inserted into the food chute located in the removable cover of the food processor unit.

5. The integrated cooking appliance of claim 4, further comprising:
a first food processor bushing located within the platform directly above the food processor motor, wherein the first food processor bushing is configured to connect a first end of a food processor shaft to the food processor motor shaft; and
a second food processor bushing located within the second portion beneath the food processor blade, wherein the second food processor bushing is configured to rotatably attach a second end of the food processor shaft to a central hub of a selected food processor blade.

6. The integrated cooking appliance of claim 5, further comprising:
a food processor carafe having an open end and a base end; and
an opening located in a center of the base end of the food processor carafe, wherein the opening is configured to receive the second food processor bushing,
wherein the first end of the food processor shaft is configured to pass through the open end and insert through the first food processor bushing into a central opening of the food processor blade.

7. The integrated cooking appliance of claim 6, further comprising:
a cooking pan configured to fit over the heating element, wherein the heating element is electrically connected to a first switch of a plurality of selectable switches;
a thermally resistant handle configured to attach to a side of the cooking pan; and
a plurality of cooking pan lids, wherein each cooking pan lid is configured to cover the cooking pan during cooking.

8. The integrated cooking appliance of claim 7, wherein the cooking pan and the plurality of cooking pan lids are coated with polytetrafluoroethylene.

9. The integrated cooking appliance of claim 8, wherein the cooking pan and the plurality of cooking lids include a solid lid configured with a steam hole and a slotted lid.

10. The integrated cooking appliance of claim 7, further comprising:
a blender handle connected to the blender carafe; and
a food processor handle connected to the food processor carafe, wherein the blender handle, the food processor handle and the thermally resistant handle are rubber.

11. The integrated cooking appliance of claim 7, further comprising:
a circuit board including a microprocessor located in the upper compartment within the central portion;
a plurality of selectable switches located in the second portion, wherein the plurality of selectable switches are operatively connected to the microprocessor; and
a plurality of selectable buttons located within the removable cover, wherein the plurality of selectable buttons are capacitively connected to the plurality of selectable switches.

12. The integrated cooking appliance of claim 11, wherein the plurality of selectable buttons includes:
an ON/OFF button capacitively connected to an ON/OFF switch;
a food processing button capacitively connected to a food processor switch;
a blending button capacitively connected to a blender switch; and
a heating button capacitively connected to a heater switch.

13. The integrated cooking appliance of claim 12, further comprising:
a wiring harness connected to the plurality of selectable switches, wherein the wiring harness includes:
a first wire configured to connect the ON/OFF switch to the microprocessor;
a second wire configured to connect the food processor switch to the food processor motor;
a third wire configured to connect the blender switch to the blender motor;
a fourth wire configured to connect the heater switch to the heating element; and
a fifth wire configured to connect the circuit board to a power source.

14. The integrated cooking appliance of claim 1, further comprising:
a layer of thermal insulation located within the second side of the appliance base below the heating element; and
a first non-slip mat configured to cover a lower surface of the appliance base.

15. The integrated cooking appliance of claim 1, further comprising:
a savor moment computing application registered to a user of the integrated cooking appliance, wherein the savor moment computing application includes:
a registration database configured to store an identification number of the integrated cooking appliance;
a recipe database accessible by the user of the savor moment computing application;
a personalized recipe memory configured to store favorite recipes and to receive recipes entered by the user; and
a sharing interface configured to connect registered users with one another to share recipes.

16. A method of using an integrated cooking appliance system, comprising:
selecting, by a user of the integrated cooking appliance system, a set of instructions for preparing a recipe from a group of food ingredients by one or more of slicing, cutting and dicing a first portion of the group of food ingredients, blending a second portion of the group of food ingredients and cooking a third portion of the group of food ingredients;
placing the first portion of the group of the food ingredients into a food processor carafe;
placing the second portion of the group of the food ingredients into a blender carafe;
placing the third portion of the group of the food ingredients into a cooking pan;
placing a lid selected from a plurality of cooking pan lids over the cooking pan;
rotating upward, by a hinge connected to a first side of a central support structure, a platform connected to the hinge, wherein the platform is located at a height halfway between an appliance base and an upper compartment of an integrated cooking appliance of the integrated cooking appliance system;
inserting, by the user, the blender carafe onto an appliance base located on the first side of a central support structure of the integrated cooking appliance and beneath the platform;
inserting a first end of a blender shaft into a blender lid, a blender bushing and a blender motor located within the platform;
inserting, by the user, a second end of the blender shaft into the blender carafe, wherein the second end is configured with a whisk blade;
covering, by the user, the blender carafe and blender lid by rotating the platform downward;
inserting, by the user, the food processor carafe into a food processor receiving region located on an upper surface of the platform;
inserting, by the user, a first end of a food processor shaft to a first food processor bushing located within the platform directly above a food processor motor, wherein the first food processor bushing is configured to connect the first end of the food processor shaft through an opening in a base of the food processor carafe to the food processor motor located within the platform;
inserting, by the user, a food processor blade consisting of one of a slicing, cutting and dicing blade as required by the instructions into a blade drawer located in an upper compartment of a central support structure integrated cooking appliance;
inserting, by the user, a second end of the food processor shaft into a second food processor bushing located within the upper compartment beneath the food processor blade and into a central hub of the food processor blade;
placing, by the user, the cooking pan over a heating element located on the base on a second side of the central support structure; and
preparing the recipe by actuating one or more of the blender motor, the food processor motor and the heating element, as required by the set of instructions.

17. The method of claim 16, further comprising:
connecting, by the user, a blender handle to the blender carafe;
connecting, by the user, a food processor handle to the food processor carafe; and
connecting, by the user, a thermally resistant cooking pan handle to the cooking pan.

18. The method of claim 17, further comprising:
connecting, by the user, an electrical plug of the integrated cooking appliance to an electrical source;
turning the integrated cooking appliance ON by pressing an ON/OFF button of the integrated cooking appliance; and
performing, by the user, one or more of:
actuating the food processor motor by pressing a food processing button,
actuating the blender motor by pressing a blending button, and
actuating the heating element by pressing the heating button.

19. The method of claim 18, further comprising:
downloading, to a smartphone of a user of an integrated cooking appliance, a savor moment computing application associated with the integrating cooking appliance;
registering, by the user, the smartphone to the savor moment computing application; and
selecting, by the user, the recipe from a recipe database accessible by the savor moment computing application, wherein the selected recipe includes the set of instructions for preparing the recipe.

20. The method of claim 19, further comprising:
saving, by the user, the selected recipe to a memory of the savor moment computing application as a favorite;
connecting, by the user, with other users of the savor moment computing application; and
blogging, by the user, with the other users.
